(19) United States
(12) Patent Application Publication
(10) Pub. No.: US 2026/0307186 A1
(43) Pub. Date: Oct. 8, 2026

(54) MANUFACTURING ARRANGEMENT

(71) Applicant: INTERROLL HOLDING AG, Sant'Antonino (CH)

(72) Inventors: Jörg Lemke, Hückelhoven (DE); Ralf Dorok, Hückelhoven (DE)

(21) Appl. No.: 19/483,076

(22) PCT Filed: May 13, 2024
(86) PCT No.: PCT/EP2024/063031

§ 371 Date: Nov. 10, 2025

(30) Foreign Application Priority Data
May 12, 2023 (EP) 23173146.4

(51) Int. Cl. B23P 23/06; B23D 45/00; B23P 15/00; B65G 13/00

(52) U.S. Cl. CPC B23P 23/06; B23P 15/00; B23D 45/003; B65G 13/00

(57) ABSTRACT

Manufacturing arrangement (10), adapted to manufacture a roller tube (81) and an axle shaft (82) of a conveyor roller (8) and to provide the axle shaft (82) provided loosely within the roller tube (81); in particular wherein a length (L) of the shaft (82) is larger than a length (l) of the tube (81); the manufacturing arrangement (10) including a tube line (20) adapted to manufacture a roller tube (81) from a rare tube material (81r); a shaft line (30) adapted to manufacture an axle shaft (82) from a rare shaft material (82r); and an assembly line (40) adapted to insert the axle shaft (82) into the roller tube (81).

### CROSS-REFERENCE TO RELATED APPLICATIONS

This is a US national phase entry application under 35 U.S.C. 371 of international patent application no. PCT/EP 2024/063031 filed 13 May 2024, which claims priority to European patent application no. 23173146.4, filed 12 May 2023; each of which is herein incorporated by reference in its entirety.

### TECHNICAL FIELD

The invention refers to a manufacturing arrangement for at least partially manufacturing or partially manufacturing a conveyor roller.

### BACKGROUND OF THE DISCLOSURE

Conveyor rollers, in particular idler rollers without having an internal drive motor, are provided with a roller tube and a axis shaft leading completely through the tube. Even if the conveyor rollers have always the same overall structure, the complexity of combinations is quite high.

Production facilities for rollers and the like are described in DE 201 03 367 U1, DE 88 08 519 U1 and DE 10 2016 112 051 A1.

It is the object of the present invention to provide an improved way of manufacturing a conveyor roller. The object is solved by a conveyor roller and a conveyor arrangement according of the main claims; embodiments are subject of the subclaims and the description.

### SUMMARY OF THE DISCLOSURE

The invention proposes to produce a shaft and a tube in parallel to each other directly and to assemble them directly after production of the tube and shaft.

The tube and the shaft are therefore manufactured on demand directly from the rare material, that means that no stock of tubes and shafts is to be maintained.

In particular the manufacturing arrangement is adapted to change the configuration of the produced tubes and shafts, in particular length and/or diameter of the tubes and/or shafts, during the running operation.

### BRIEF DESCRIPTION OF THE DRAWINGS

An example embodiment of the invention is described in more detail with the help of the figures; herein show

FIG. 1 a conveyor zone in perspective view;

FIG. 2 a longitudinal section of an idler roller of the conveyor zone of FIG. 1;

FIG. 3. three examples of different shaft configurations in longitudinal section;

FIG. 4 a schematic representation of an inventive manufacturing arrangement;

FIG. 5 a more detailed schematic representation of a tube line of the inventive manufacturing arrangement of FIG. 4;

FIG. 6 a more detailed schematic representation of a shaft line of the inventive manufacturing arrangement of FIG. 4;

FIG. 7 a table of operation cycles along with output/input values and a buffer occupation within the tube line of FIG. 5 or shaft line of FIG. 6;

FIG. 8 a diagram of the table of FIG. 7.

### DETAILED DESCRIPTION

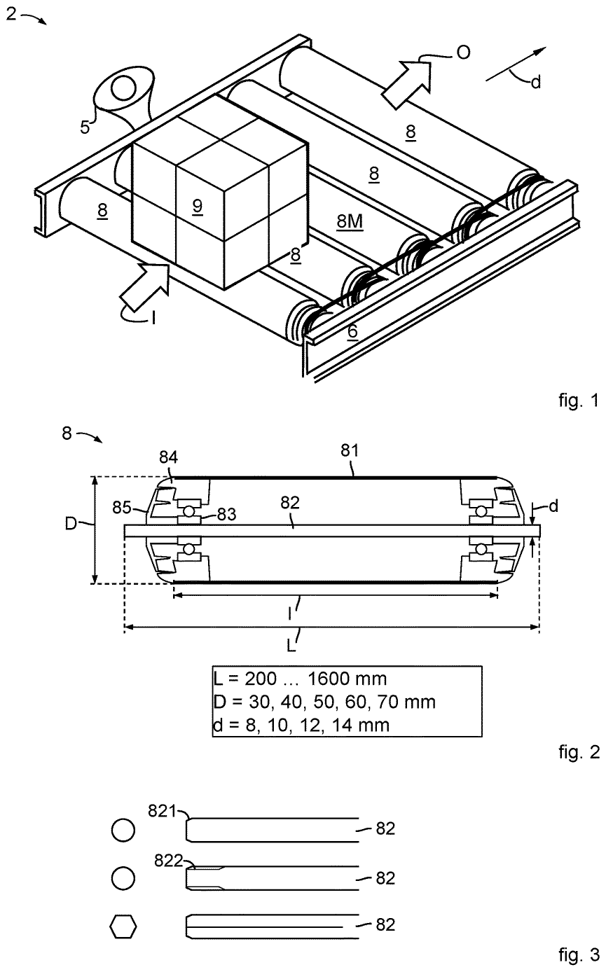

FIG. 1 shows an exemplary conveyor zone 2, comprising several conveyor rollers 8 which are driven together. The roller are attached to a common frame 6. For this purpose, one of the conveyor rollers is designed as a motorized conveyor roller 8M. The motorized conveyor roller 8M is driven by a, in particular three-phase, motor arranged within the conveyor roller 8M. The remaining rollers 8 are idler rollers, not comprising an internal drive motor. Via one or more drive connectors, e.g. a drive belt, the conveyor rollers 8 of a conveyor zone 2 are drive-connected to each other and are jointly driven by the motorized conveyor roller 8M. An object 9 is linearly conveyed from an inlet I to an outlet O along a conveying direction d.

By means of a presence sensor 5, the presence of a conveyed object 9 arranged on the conveyor zone 2 can be determined. The presence sensor 5 does not necessarily cover the entire conveyor zone 2; it is sufficient if the presence of a conveyed object 9 within a partial area of the conveyor zone 2 is detected by the presence sensor 5. The presence sensor 5 thereby generates a sensor signal, which is connected via a signal line (not shown) to a zone controller (not shown).

FIG. 2 shows an exemplary idler roller 8 in longitudinal view. The roller 8 has a roller tube 81, which is held rotatably around axle shaft 82 by means of a bearing 83. Attached to the roller tube 81 is a bearing housing 84. An endcap 85 fixed to the axle shaft 82 covers the bearing 83.

The idler roller 8 shown in FIG. 2 is merely an example of a variety of options:

As an example an overall length L of the roller can adopt any value from 100 mm to 1600 mm.

As an example the roller tube outer diameter D can adopt the following discrete values: 30, 40, 50, 60 mm.

As an example the axle shaft diameter d can adopt the following discrete values: 8, 10, 12, 14 mm.

As an example the axle shaft 82 may comprise the following features (see FIG. 3):

The axle shaft 82 may have an circular or hexagonal cross-section.

The axle shaft 82 may have a chamfer 821.

The axle 82 shaft may have a threaded end portion 822.

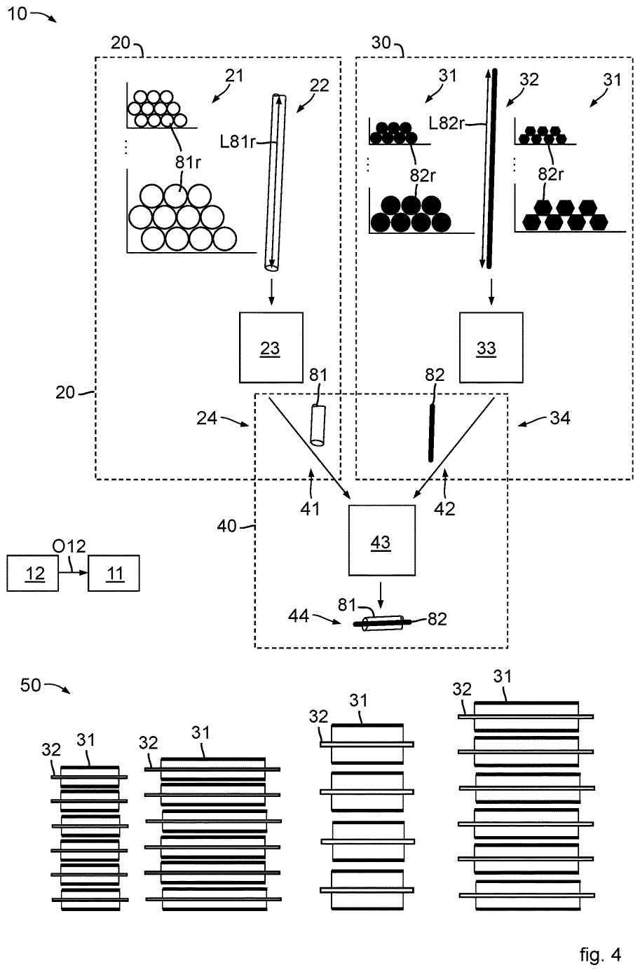

FIG. 4 shows a manufacturing arrangement 10 which is used in the process of manufacturing at least parts of the aforementioned idler roller 8. The manufacturing arrangement 10 comprises a tube line 20, a shaft line 30 and an assembly line 40.

In the tube line 20, a rare tube material 8r is provided in a stock 21 of rare tube material 81r. The rare tube material 81r comprises tubes of a length of about 2-5 m length and of different diameters. Depending on an actual order a rare tube material is selectively taken from the stock 21 and provided to a tube processing 23 by a tube material infeed 22. The tube processing 23 processes the rare tube material 81r and provides the finished tubes 81 at an tube outlet 24.

In the shaft line 30 a rare shaft material 82r is provided in a stock 31 of rare shaft material 82 r. The rare shaft material 82r comprises shafts of a length of about 2-5 m length and of different diameters. Depending on an actual order a rare shaft material 82r is selectively taken from the stock 31 and provided to a shaft processing 33 by a shaft material infeed 32. The shaft processing 33 processes the rare shaft material 82r and provides finished shafts 82 at a shaft outlet 34.

The finished tubes 81 are transferred to a tube input 41 of said assembly line 40. Alternatively the tube input 41 may be identical to the tube outlet 24.

The finished shafts 82 are transferred to a shaft input 42 of said assembly line 40. Alternatively the shaft input 42 may be identical to the shaft outlet 34.

In an assembly processing 43 of the assembly line 40 the finished shafts 82 are inserted into the finished tubes 81 and provided to an assembly outlet 44.

From the assembly output 44 the tubes and shafts are transferred to a stock 50.

Transferring the rare material from the stock 21, 31 to the infeeds 22, 32 can be done automatically or manually. Transferring the assembled tubes 81 and shafts 82 from assembly output 44 to the stock 50 can be done automatically or manually.

All steps between the infeeds 22, 32 and the outlet are done automatically and in particular in unchanged sequence.

Unchanged sequence means, that a tube/shaft section which is at first entering the processing 23, 33 will leave the assembly processing at first. A tube/shaft section which is entering at second position the processing 23, 33 will leave the assembly processing after the first shaft/axle section.

A control 11 automatically controls operation of the arrangement 10.

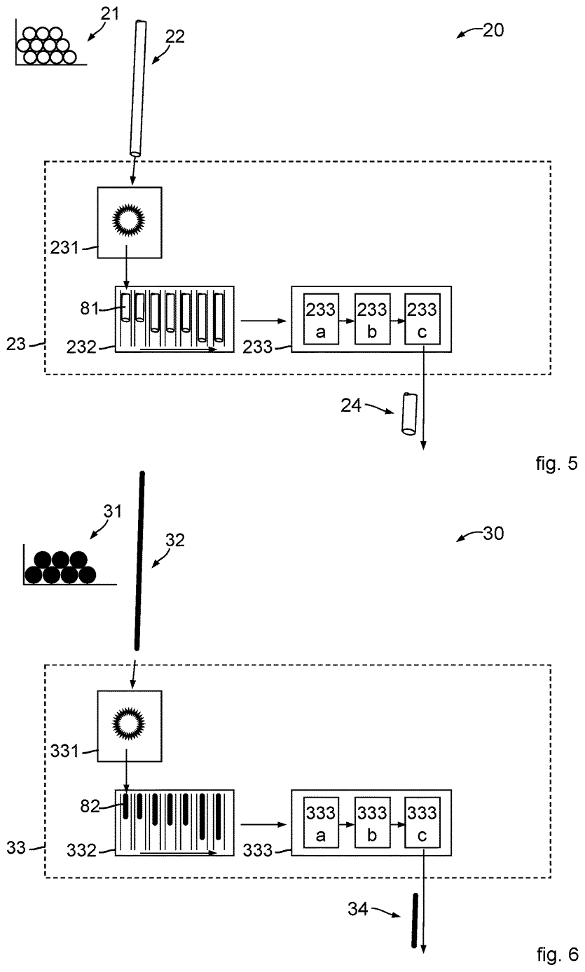

FIG. 5 shows the tube line 20 in more detail. The tube processing comprises a sawing station 231, to which the rare tube material 81r from the tube infeed 22 is transferred to. Here the tube material is sawn into tube 81 of the final length required for the intended roller.

Afterwards the tube 81 is transferred on a tube buffer station 232, where a plurality of tubes are buffered and waiting for the next processing steps. Behind the buffer the tubes 81 are transferred to a tube finishing station 233. The tube finishing station 233 comprises one or a plurality of sub devices 233a, b, c, where the tube 81 is subject to a treatment. As an example, at a first finishing device 233a tube may be subject of a drilling or chamfering at the tube ends. At a second finishing device 233b the tube 81 may be subject of a measuring action. In a third finishing device 233c, the tube 81 may be subject to a cleaning action, in particular to remove any chipping. There are various other finishing steps possible depending on the final design of the tube.

FIG. 6 shows the shaft line 30 in more detail. The shaft processing comprises a sawing station 331, to which the rare shaft material 82r from the shaft infeed 32 is transferred to. Here the shaft material is sawn into shaft 82 of the final length required for the intended roller.

Afterwards the shaft 82 is transferred on a shaft buffer station 332, where a plurality of shafts are buffered and waiting for the next processing steps. Behind the buffer the shafts 82 are transferred to a shaft finishing station 333. The shaft finishing station 333 comprises one or a plurality of sub devices 233a, b, c, where the shaft 82 is subject to a treatment. As an example, at a first finishing device 333a tube may be subject of a labelling and measuring action. At a second finishing device § 33b the shaft 82 may be subject to chamfering to generate said chamfer 821 and/or drilling of a center bore at the shaft ends. In a third finishing device 333c, said outer thread 822 or an inner thread may be drilled into the ends of said shaft 82. There are various other finishing steps possible depending on the final design of the shaft.

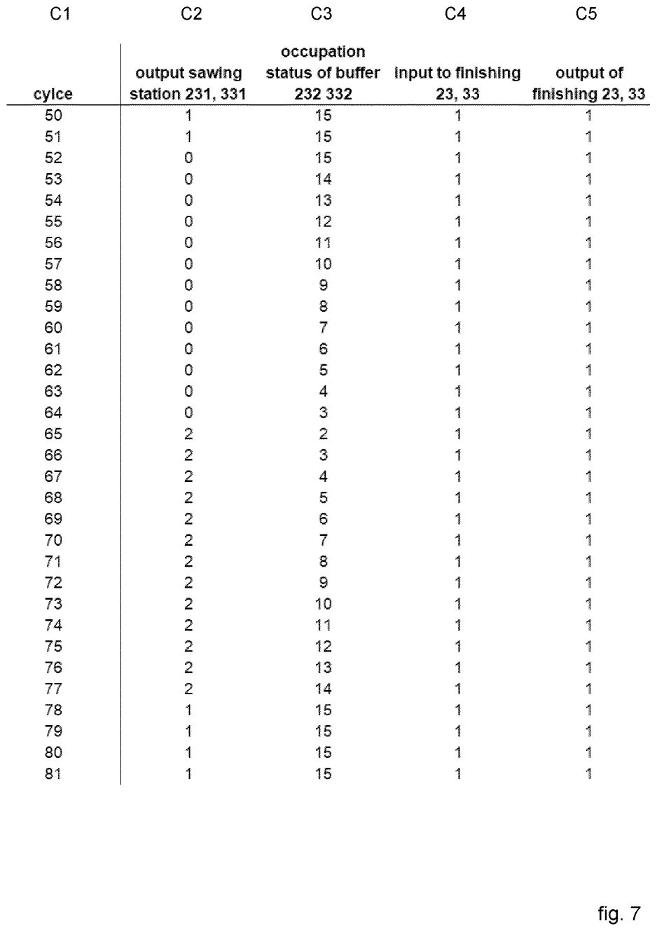

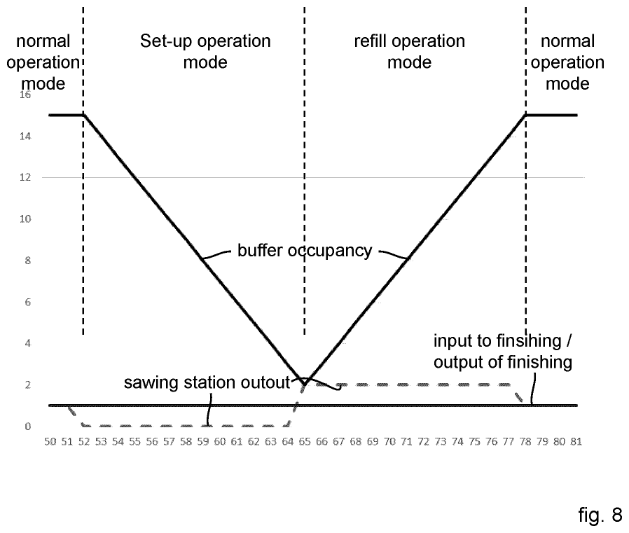

Of particular relevance are the buffer stations 232, 332, which are described subsequently with reference to FIGS. 7 and 8. The following description is relevant for one or each of the tube buffer station 232 or the shaft buffer station 332.

The manufacturing arrangement 10 operates according to an overall operating cycle time of e.g. max. 5 seconds. Within each cycle, one tube 81/shaft 82 is processed within one finishing device 233a, b, c, 333a, b, c including the transfer to the next device.

This is shown in the table (FIG. 7) and the respective diagram (FIG. 8). Here an exemplary list of cycles starting from cycle number 50 to cycle number 80 (column C1) are shown. According to column C5, the finishing station always provides an output of one unit per cycle. Accordingly, one unit per cycle is to be delivered to the input of the finishing station (column C4).

In cycle 50 all fifteen buffer position are occupied (column C3), so there is a buffer occupation rate of 100%. As long as there is an occupation status of at least “1”, the finishing station is operable. As soon as the there is an occupation status of “0”, the finishing station is not operable in the next cycle.

In the cycles 50 and 51 the sawing station provides an output of one unit per cycle (column C2). As a consequence, the buffer station is in each cycle provided with the same number of units, which are required by the subsequent finishing station and transferred from the buffer station to the finishing station.

The control 11 controls the arrangement based on an order O12 provided by a order management system 12. The order O12 comprises all necessary information for the control, so that the control is adapted to control the arrangement in a manner so that at the assembly output the requested products are provided.

In particular the orders O12 comprises information about the rare materials to be used for the next period of operation, which is different to the rare material which was used for a previous period of operation.

Accordingly to the order, after the cycle 52 a different type of rare material should be provided at the cycles 52 and 64. As an example the new different type of rare material may be characterized by a different tube/shaft diameter, a different cross section (e.g. round or a hexagonal axle shaft), rare material length, a different materiel type, . . . ).

Due to the change to a new rare material the material infeed 22, 32 and/or the sawing station 231, 331 needs to be setup to the new material. This set-up cannot be performed within one cycle. Instead, this set up may take up to about 1 minute.

The units available in the buffer station 232, 323 ensure, that the finishing station is kept in operation at least for the next 15 cycles. During these 15 cycles the infeed 22, 32 and/or the sawing station 231, 331 is setup for the new material.

As a consequence, starting from the cycle 52 the sawing station does not provide any units per cycle. The buffer nevertheless provides one unit per cycle as requested by the finishing station, but the buffer occupation is decreasing in each cycle by one unit.

After 13 cycles at cycle number 65, the infeed station and/or the sawing station are back in operational condition and the buffer occupation is reduced to two units. Now the infeed station and the sawing station are operated at an increased output rate of two units per cycle.

Accordingly the buffer occupation is increased by one units per cycle. At cycle number 78 the buffer occupation is again at 15 units (100% buffer occupation rate).

The operation of the shaft line 30 is synchronized to the operation of the tube line 20, so that always a shaft 82 provided at the shaft outlet 34 matches to a tube 81 provided at the tube outlet 24. In case that in the tube line a scrap part is identified, this scrap part will not be forwarded into the assembly line 40 for being assembled by the corresponding shaft. However to avoid any mismatches, the shaft 82, which matches to the “scrap”-tube 81 is also removed and will not be provided at the assembly line 40. Same applies for the case that a shaft is identified as a scrap part; accordingly the tube 81, which matches to the “scrap”-shaft 82 is being removed before the assembly line.

In case that a scrap part has been identified, the control of the assembly is adapted to initiate a reproduction of the removed scrap parts.

In an embodiment the reproduction of said scrap part is before or after a subsequent production order, taking into account the raw materials used for the subsequent order in comparison with the raw materials used for the reproduction of said scrap part. Usually the reproduction of a scrap part requires, that merely one part of a certain specification is to be produced. It therefore efficient, to schedule the reproduction at time, where part are produced using similar rare materials. So if the scrap part is a tube of a certain diameter, the reproduction is performed in sequence with the production of other tube of the same diameter. Now the assembly can use the same rare materials for the production of the scrap part as for the parts scheduled immediately before or after the production of the scrap part.

### LIST OF REFERENCE SIGNS

2 conveyor zone
5 presence sensor
6 frame
8 conveyor (idler) roller
8M motorized roller
81 roller tube
81r rare tube material
82 axle shaft
82r rare shaft material
821 chamfer
822 threaded portion
83 bearing
84 bearing housing
85 end cap
9 object to be conveyed
L (installation) length
D tube (outer) diameter
d shaft diameter
O12 order
10 manufacturing arrangement
11 control
20 tube line
21 stock of rare tube material
22 rare tube material infeed
23 tube processing
231 tube sawing station
232 tube buffer station
233 tube finishing station
24 tube outlet
30 shaft line
31 stock of rare shaft material
32 rare shaft material infeed
33 shaft processing
331 shaft sawing station
332 shaft buffer station
333 shaft finishing station
34 shaft outlet
40 assembly line
41 assembly tube input
42 assembly shaft input
43 assembly processing
44 assembly output
50 stock of assembled tubes and shafts

1. A manufacturing arrangement (10), adapted to manufacture a roller tube (81) and an axle shaft (82) of a conveyor roller (8) and to provide the axle shaft (82) provided loosely within the roller tube (81);
in particular wherein a length (L) of the shaft (82) is larger than a length (l) of the tube (81);
the manufacturing arrangement (10) comprising:
a tube line (20) adapted to manufacture a roller tube (81) from a rare tube material (81r),
a shaft line (30) adapted to manufacture an axle shaft (82) from a rare shaft material (82r),
an assembly line (40) adapted to insert the axle shaft (82) into the roller tube (81).

2. The manufacturing arrangement (10) according to claim 1,
characterized in
that a length (L81r) of the rare tube material (81r) is a plurality of the length (I) of the tube (81) and/or has a length of at least 2 m; and/or
that a length (L82r) of the rare shaft material (82r) is a plurality of the length (L) of the shaft (82) and/or has a length of at least 2 m.

3. The manufacturing arrangement (10) according to claim 1,
characterized in
that the tube line (20) comprising:
a rare tube material infeed (22),
a tube sawing station (231),
a tube finishing station (233), and
a tube outlet (24);
wherein the rare tube material infeed (22) is adapted to provide the rare tube material to the tube sawing station (231);
wherein the tube sawing station (231) is adapted to saw the rare tube material into a plurality of tubes (81) individually to a desired tube length (I);
wherein the tube finishing station (233) is adapted to perform a finishing operation to the tubes (81), in particular the finishing operation is selected individually for an individual tube;
wherein subsequently to the finishing station the tubes (81) are provided at the tube outlet (24).

4. The manufacturing arrangement (10) according to claim 1,
characterized in
that the shaft line (30) comprising:
a rare shaft material infeed (32),
a shaft sawing station (331),
a shaft finishing station (333), and
a shaft outlet (34);
wherein the rare shaft material infeed (32) is adapted to provide the rare shaft material to the shaft sawing station (331);
wherein the shaft sawing station (331) is adapted to saw the rare shaft material into a plurality of shafts (82) individually to a desired shaft length (L);
wherein the shaft finishing station (333) is adapted to perform a finishing operation to the shafts (82), in particular the finishing operation is selected individually for an individual shaft;
wherein subsequently to the finishing station the shafts (82) are provided at the shaft outlet (34).

5. The manufacturing-arrangement (10) according to the claim 3,
characterized in
that during normal mode
the finishing station (233, 333), in particular the tube finishing station and/or the shaft finishing station, is adapted to output one tube (81) and/or one shaft (82) in a predetermined cycle time.

6. The manufacturing arrangement (10) according to claim 1,
characterized in
that during normal operation mode
the material infeed (22, 32), in particular the tube material infeed (22) and/or the shaft material infeed (32), and/or
the sawing station (231, 331), in particular the tube sawing station (231) and/or the shaft sawing station (331),
is adapted to output one tube (81) and/or shaft (82) within said predetermined cycle time.

7. The manufacturing arrangement (10) according to claim 1,
characterized in
that during a set-up mode
the material infeed (22, 32), in particular the tube material infeed (22) and/or the shaft material infeed (32), and/or
the sawing station (231, 331), in particular the tube sawing station (231) and/or the shaft sawing station (331),
is adapted to output no tube (81) and/or shaft (82);
wherein during said set-up mode the subsequent finishing station (233, 333) is adapted to continue outputting one tube (81) and/or shaft (82) within in said predetermined cycle time.

8. The manufacturing Me g-arrangement (10) according to claim 1,
characterized in
that between
said sawing station (231, 331), in particular the tube sawing station (231) and/or the shaft sawing station (331), and
said finishing station (233, 333), in particular the tube finishing station and/or the shaft finishing station,
a buffer station (232, 332), in particular a tube buffer station (232) and/or a shaft buffer station (332) is provided;
wherein the buffer station (232, 332) is adapted to output one tube (81) and/or shaft (82) within in said predetermined cycle time during the set-up mode, in particular independent from the output of the said sawing station (231, 331).

9. The manufacturing arrangement (10) according to claim 1,
characterized in
that in a refill mode
said material infeed (22, 32), in particular the tube material infeed (22) and/or the shaft material infeed (32), and/or
the sawing station (231, 331), in particular the tube sawing station (231) and/or the shaft sawing station (331),
is adapted to output more than one tube (81) and/or shaft (82) within said predetermined cycle time;
wherein in said refill mode the finishing station (233, 333), in particular the tube finishing station and/or the shaft finishing station, is adapted to output one tube (81) and/or one shaft (82) in said predetermined cycle time;
in particular the output rate of the material infeed (22, 32) and/or the sawing station is larger than an output rate of the finishing station (233, 333) during the refill mode.

10. The manufacturing arrangement (10) according to claim 1,
characterized in
that the manufacturing arrangement (10) is adapted to identify a tube (81) within the tube line (20) and/or a shaft (82) within the shaft line (30) as a scrap part and in particular to remove the scrap part from the manufacturing arrangement (10);
that the manufacturing arrangement (10) is adapted to identify a shaft (82) and/or a tube (81) within the respective other line (30, 20) which is intended to be assembled with the identified scrap part and in particular to remove the identified shaft (82) and/or a tube (81) part from the manufacturing arrangement (10).

11. The manufacturing arrangement (10) according to claim 10,
characterized in
that upon identification of a tube (81) or a shaft (82) within as a scrap part:
the manufacturing arrangement (10) is adapted to automatically initiate a reproduction of the scrap part.

12. The manufacturing arrangement (10) according to claim 11,
characterized in
the manufacturing arrangement (10) is adapted
to schedule the reproduction of said scrap part immediately after or before a subsequent order, taking into account the raw materials used for the subsequent orders in comparison with the raw materials used for the reproduction of said scrap part.

13. Use of a manufacturing arrangement (10) according to claim 1.

14. Use according to he preceding claim 13,
wherein the manufacturing arrangement (10) operates on the basis of an order (O12) received from a order management system (12).

15. Use according to claim 14,
wherein said order (O12) requires the manufacturing arrangement (10) being prepared within a setup-mode,
where during said setup-mode
a material infeed (22, 32), in particular a tube material infeed (3222) and/or a shaft material infeed (32), and/or
sawing station (231, 331), in particular the tube sawing station (231) and/or the shaft sawing station (331),
is being setup to a operate according to a received order (O12)
in particular without affecting an output rate of the Manufacturing Arrangement (10)
in particular a assembly line of the manufacturing arrangement.
